(19) United States
(12) Patent Application Publication
(10) Pub. No.: US 2004/0048767 A1
(43) Pub. Date: Mar. 11, 2004

(54) Detergent composition comprising hydrophobically modified polyamines

(75) Inventors: Kenneth Nathan Price, Wyoming, OH (US); Rafael Ortiz, Milford, OH (US); Jeffrey John Scheibel, Loveland, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/651,770

(22) Filed: Aug. 29, 2003

Related U.S. Application Data
(60) Provisional application No. 60/407,049, filed on Aug. 30, 2002.

(51) Int. Cl. C11D 1/00

(52) U.S. Cl. 510/499

(57) ABSTRACT

The present invention relates to a detergent composition comprising a hydrophobically modified polyamine with polyalkyleneoxy capped units where at least one polyalkyleneoxy capped unit is an anionic capping unit, with the hydrophobically modified polyamine quatemized with at least one hydrophobic quaternizing unit, but having less than all of the hydrophobically modified polyamine quaternized with a hydrophobic quaternizing unit; wherein the detergent composition further comprises a surfactant system, carriers, and adjunct ingredients.

### CROSS-REFERENCE

This application claims benefit under 35 USC 119 (e) to U.S. application Ser. No. 60/407,049, filed Aug. 30, 2002.

### FIELD OF THE INVENTION

The present invention relates to laundry detergent compositions comprising one or more hydrophobically modified polyamines that provide enhanced hydrophilic soil, inter alia, clay, removal benefits. The present invention also relates to methods for removing hydrophilic soil form wearing apparel.

### BACKGROUND

Fabric, especially clothing, can become soiled with a variety of foreign substances ranging from hydrophobic stains (grease, oil) to hydrophilic stains (clay). The level of cleaning that is necessary to remove said foreign substances depends to a large degree upon the amount of stain present and the degree to which the foreign substance has contacted the fabric fibers. Grass stains usually involve direct abrasive contact with vegetative matter thereby producing highly penetrating stains. Clay soil stains, although in some instances contacting the fabric fibers with less force, nevertheless provide a different type of soil removal problem due to the high degree of charge associated with the clay itself. This high surface charge density may act to repel some laundry adjunct ingredients, inter alia, clay dispersants, thereby resisting any appreciable peptization and dispersal of the clay into the laundry liquor.

A surfactant per se is not all that is necessary to remove unwanted clay soils and stains. In fact, most surfactants by themselves in water are surprisingly poor at removing clay soils from fabric. Not all surfactants work equally well on all types of stains. In addition to surfactants, polyamine-based hydrophilic soil dispersants are added to laundry detergent compositions to “carry away” clay soils from the fabric surface and to stabilize the removed particles in solution sufficiently to minimize the possibility that the clay soil will be re-deposited upon the fabric. However, unless the clay can be initially removed from the soiled fabric, especially in the case of hydrophilic fibers, inter alia, cotton, there will be nothing in solution for the dispersants to bind to and keep suspended.

It has been known to include hydrophobically modified polyamines in detergent composition, however it has been surprisingly found that a hydrophobically modified polyamine having non-homogeneous quaternization and/or partial quaternization demonstrates a higher efficacy than known hydrophobically modified polyamine structures.

Additionally it has been surprisingly found that when non-homogeneous quaternization and/or partial quaternization is combined with 50% or less by moiety of an anionic capping unit, higher efficacy is demonstrated than known hydrophobically modified polyamine structures.

### SUMMARY OF THE INVENTION

The present invention relates to a detergent composition comprising

a) from about 0.01%, preferably from about 0.1%, more preferably from about 1%, most preferably from about 3% to about 50%, preferably to about 20%, more preferably to about 10%, most preferably to about 7% by weight of a hydrophobically modified polyamine having formula (I):

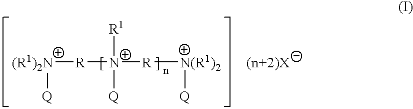

wherein R is C₆-C₂₀ linear or branched alkylene, and mixtures thereof; X in formula (I) is an anion present in sufficient amount to provide electronic neutrality; n in formula (I) has the value from about 0 to about 4; R¹ in formula (I) is a capped polyalkyleneoxy unit having formula (II):

—(R²O)ₓ—R³ (II)

wherein R² in formula (II) is C₂-C₄ linear or branched alkylene, and mixtures thereof; x in formula (II) is from about 1 to about 50; at least one R³ moiety in formula (II) is an anionic capping unit, with the remaining R³ moieties in formula (II) selected from the group comprising hydrogen, C₁-C₂₂ alkylenearyl, an anionic capping unit, a neutral capping unit, and mixtures thereof; at least one Q moiety, but less than all Q moieties in formula (I) are hydrophobic quatemizing units selected from the group comprising C₇-C₃₀ substituted or unsubstituted alkylenearyl, and mixtures thereof, with the remaining Q moieties in formula (I) selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof;

b) a surfactant system comprising from about 0.01% by weight, of a surfactant system comprising one or more surfactants selected from:

i) from 0% to 100% by weight, of one or more anionic surfactants;

ii) from 0% to 100% by weight, of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof; and

c) the balance carriers and adjunct ingredients.

The present invention further relates to a detergent composition comprising:

A) from about 0.01% by weight of a hydrophobically modified polyamine having formula (III):

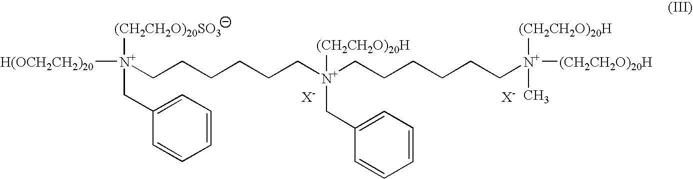

wherein X in formula (III) is a water soluble anion selected from the group comprising chlorine, bromine, iodine, methylsulfate, and mixtures thereof

B) from about 0.01% to about 60% by weight, of a surfactant system comprising one or more surfactants selected from:

i) from 0% to 100% by weight, of one or more anionic surfactants;

ii) from 0% to 100% by weight, of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof;

C) the balance carriers and adjunct ingredients.

The present invention further relates to a detergent composition comprising:

A) from about 0.01% by weight of a hydrophobically modified polyamine having formula (IV):

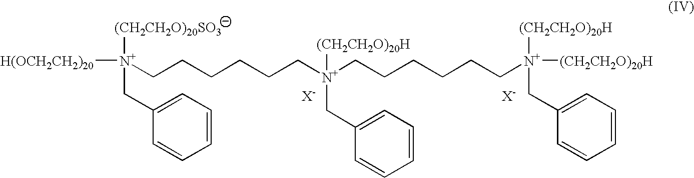

wherein X in formula (IV) is a water soluble anion selected from the group comprising chlorine, bromine, iodine, methylsulfate, and mixtures thereof

B) from about 0.01% to about 60% by weight, of a surfactant system comprising one or more surfactants selected from:

i) from 0% to 100% by weight, of one or more anionic surfactants;

ii) from 0% to 100% by weight, of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof;

C) the balance carriers and adjunct ingredients.

The present invention further relates to a method for cleaning fabric comprising the step of contacting an article of fabric with an aqueous solution containing at least 0.1% by weight of a composition comprising:

A) from about 0.01% to about 50% by weight of a hydrophobically modified polyamine having formula (I):

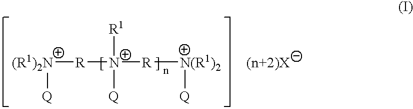

wherein R is C₅-C₂₀ linear or branched alkylene, and mixtures thereof; X in formula (I) is an anion present in sufficient amount to provide electronic neutrality; n in formula (I) has the value from about 0 to about 4; R¹ in formula (I) is an alkyleneoxy unit having formula (II):

—(R²O)ₓ—R³ (II)

wherein R² in formula (II) is C₂-C₄ linear or branched alkylene, and mixtures thereof; R³ in formula (II) is at least one anionic unit selected from the group comprising:

i) —(CH₂)_{f}CO₂⁻;

ii) —C(O)(CH₂)_{f}CO₂⁻;

iii) —(CH₂)_{f}PO₃²⁻;

iv) —(CH₂)_{f}OPO₃²⁻;

v) —(CH₂)_{f}SO₃⁻;

vi) —CH₂(CHSO₃⁻)(CH₂)_{f}SO₃⁻;

vii) —CH₂(CHSO₂⁻)(CH₂)_{f}SO₃⁻;

viii) —C(O)CH₂CH(SO₃⁻)CO₂⁻;

ix) —C(O)CH₂CH(CO₂⁻)NHCH(CO₂⁻)CH₂CO₂⁻;

x) —CH₂CH(OH)CH₂SO₃⁻;

xi) —CH₂CH(SO₃⁻)CH₂OH;

xii) —CH₂PhSO₃⁻;

xiii) —PhSO₃⁻; and

xiv) mixtures thereof;

wherein the index f of the anionic capping units is from 0 to about 10; x in formula (II) is from about 15 to about 30; and the remaining R³ moieties in formula (II) are selected from the group comprising hydrogen, C₁-C₂₂ alkylenearyl, the anionic capping unit selected from the group above, a neutral capping unit, and mixtures thereof; and wherein at least one Q moiety, but less than all Q moieties in formula (I) are hydrophobic quaternizing units selected from the group comprising C₇-C₃₀ substituted or unsubstituted alkylenearyl, and mixtures thereof, with the remaining Q moieties in formula (I) are selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof;

B) from about 0.01% to about 60% by weight, of a surfactant system comprising one or more surfactants selected from:

i) from 0% to 100% by weight, of one or more anionic surfactants;

ii) from 0% to 100% by weight, of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof; and

C) the balance carriers and adjunct ingredients.

These and other objects, features, and advantages will become apparent to those of ordinary skill in the art from a reading of the following detailed description and the appended claims. All percentages, ratios, and proportions herein are by weight, unless otherwise specified. All temperatures are in degrees Celsius (° C.) unless otherwise specified. All documents cited are in relevant part, incorporated by reference.

### DETAILED DESCRIPTION OF THE INVENTION

For the purposes of this invention “modified polyamine” is defined herein as the reaction of a linear polyamine comprising from 2 to 20 nitrogens wherein each nitrogen has its backbone hydrogens replaced by an capped polyalkyleneoxy unit comprising at least about 1 to 50 alkyleneoxy units, with one equivalent per nitrogen of a quaternizing agent, wherein at least one quaternizing agent, but less than all quaternizing agents are hydrophobic quaternizing units selected from the group comprising C₇-C₃₀ substituted or unsubstituted alkylenearyl, and mixtures thereof, and the remaining quaternizing units are selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof.

A “polyamine” for the purposes of the present invention is defined as an amine having less than 6 backbone nitrogen atoms and no branching. The present invention defines the term “oligomeric amines”, otherwise known as oligoamines or “polymeric amines” (e.g., polyalkyleneamines or polyalkyleneimines), are defined as amines comprising more than 5 nitrogens.

Hydrophobically Modified Polyamines

The hydrophobically modified polyamines of the present invention have formula (I):

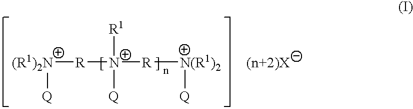

wherein R in formula (I) is C₆-C₂₀ linear or branched alkylene, and mixtures thereof; in one preferred embodiment R in formula (I) is C₆-C₁₀ linear alkylene, in another preferred embodiment R in formula (I) is C₆-C₈ linear alkylene, in yet another preferred embodiment each of the R units in formula (I) are hexylene units, typically linear hexylene units.

X in formula (I) is an anion present in sufficient amount to provide electronic neutrality. Non-limiting examples of anions are chlorine, bromine, iodine, methylsulfate, and mixtures thereof.

R¹ in formula (I) is a capped polyalkyleneoxy unit having formula (II):

—(R²O)ₓ—R³ (II)

wherein R² in formula (II) is C₂-C₄ linear or branched alkylene, and mixtures thereof. The term linear or branched as it refers to R² include any linear or branched alkylene unit comprising a total of from 2 to 4 carbon atoms. In one preferred embodiment R² in formula (II) comprises ethylene, 1,2-propylene, and mixtures thereof; in still another preferred embodiment each R² unit in formula (II) is an ethylene unit.

R³ in formula (II) is a capping unit moiety selected from the group comprising: hydrogen, C₁-C₂₂ alkylenearyl, an anionic capping unit, a neutral capping unit, and mixtures thereof. At least one R³ moiety in formula (II) comprises an anionic unit, wherein the remaining R³ moieties in formula (II) may be different capping units, or the remaining R³ moieties in formula (II) may comprise any mixture of capping units units. Non-limiting examples of anionic units are selected from the group comprising:

i) —(CH₂)_{f}CO₂⁻;

ii) —C(O)(CH₂)_{f}CO₂⁻;

iii) —(CH₂)_{f}PO₃²⁻;

iv) —(CH₂)_{f}OPO₃²⁻;

v) —(CH₂)_{f}SO₃⁻;

vi) —CH₂(CHSO₃⁻)(CH₂)_{f}SO₃⁻;

vii) —CH₂(CHSO₂⁻)(CH₂)_{f}SO₃⁻;

viii) —C(O)CH₂CH(SO₃⁻)CO₂⁻;

ix) —C(O)CH₂CH(CO₂⁻)NHCH(CO₂⁻)CH₂CO₂⁻;

x) —CH₂CH(OH)CH₂SO₃⁻;

xi) —CH₂CH(SO₃⁻)CH₂OH;

xii) —CH₂PhSO₃⁻;

xiii) —PhSO₃⁻;

xiv) and mixtures thereof;

The index f in the anionic capping units is from 0 to about 10, one preferred embodiment of the present invention fixes the range of the index f in the anionic capping units is from 0 to 2. A non-limiting example of a preferred neutral capping unit is a —CH₂Ph unit.

One preferred embodiment of the present invention relates to hydrophobically modified polyamines where the R³ moiety in formula (II) is a sulfate group listed above at a level of from about 0% by total R³ moiety to about 50% by total R³ moiety, preferably from about 15% by total R³ moiety to about 30% by total R³ moiety, more preferred around about 20% by total R³ moiety; with the remaining R³ moieties in formula (II) selected from the group comprising hydrogen, C₁-C₂₂ alkylenearyl, a neutral capping unit, and mixtures thereof.

The index x in formula (II), which describes the average number of alkyleneoxy units attached to the backbone nitrogen, is from about 1 to about 50, preferably from about 15 to about 25, more preferably from about 18 to about 23, most preferred average value of alkyleneoxy units is about 20. The formulator will recognize that when ethoxylating a polyamine, only an average number or statistical distribution of alkyleneoxy units will be known. Therefore, depending upon how “tightly” or how “exactly” a polyamine is alkoxylated, the average value may vary from embodiment to embodiment.

Q in formula (I) is a quatemizing unit where at least one Q moiety, but less than all Q moieties in formula (I) are selected from the group comprising a C₇-C₃₀ substituted or unsubstituted alkylenearyl, or mixtures thereof. The remaining Q moieties in formula (I) are selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof.

In one preferred embodiment of the present invention, at least one, but not all of the Q moieties in formula (I) are a quaternizing unit selected from the group comprising benzyl, substituted benzyl, naphthyl, substituted naphthyl, and any combinations thereof; remaining Q moieties in formula (I) selected from the group comprising: lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof.

For the purposes of the present invention the term “naphthyl” is defined as having the following formulae (V) and (VI):

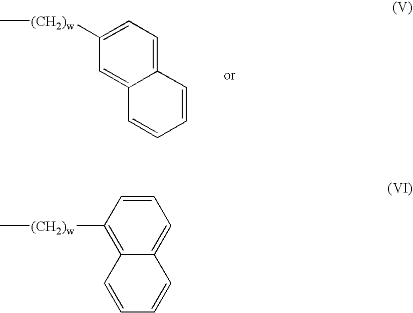

regardless upon whether said unit comprises α-substitution or β-substitution. The index w in formulae (V) and (VI) has the value from 0 to 20.

Other alkylene aryl units include besides benzyl, alkylenearyl units having the formulae (VII) and (VIII):

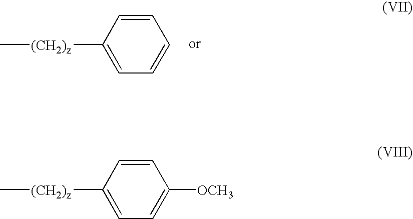

wherein the index z in formulae (VII) and (VIII) is from 1 to 24.

For the purposes of the present invention the term “substituted” as it applies to alkylenearyl units suitable as Q units in formula (I), comprise one or more C₁-C₁₂ linear or branch alkyl moieties, provided the total number of carbon atoms, including the aromatic ring structure, do not exceed 30 carbon atoms.

A non-limiting example of a substitued alkylenearyl unit according to the present invention has formula (IX):

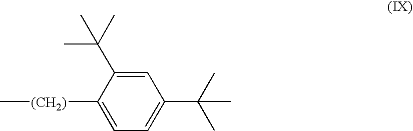

which is known as a 3,5-di-tert-butyl benzyl moiety.

In a more preferred embodiment of the present invention, the Q moiety in formula (I) comprises about 90% to about 99% by total Q moiety of C₇-C₃₀ substituted or unsubstituted alkylenearyl; more preferably the Q moiety in formula (I) comprises about 90% to about 99% by total Q moiety of benzyl, substituted benzyl, naphthyl, substituted naphthyl, and any combinations thereof; with the remaining Q moieties in formula (I) selected from the group comprising: lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof.

The index n in formula (I) represents the number of secondary nitrogens in the backbone. The index n has the value from 0 to 4, preferably from 0 to 2.

An example of a preferred hydrophobically modified polymer according to the present invention; the R³ moiety in formula (II) comprises about 50% by R³ moiety or less of sulfate groups and the Q moiety in formula (I) can be a mixture of substituted or unsubstituted alkylenearyl and C₁-C₃₀ linear or branched alkyl, C₆-C₃₀ cycloalkyl; more preferably methyl and benzyl mixtures according to formula (III) below:

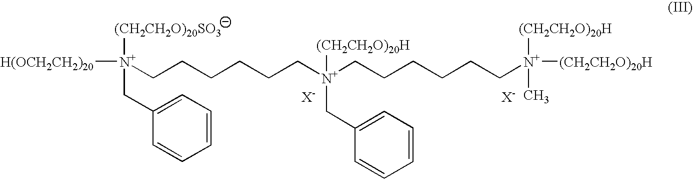

Another example of a preferred hydrophobically modified polyamine according to the present invention, the R³ moiety in formula (II) comprises about 50% by R³ moiety or less of sulfate groups and the Q moiety in formula (I) is a benzyl group comprising 90% by Q moiety according to formula (IV) below:

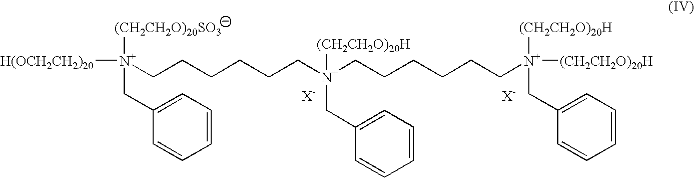

One skilled in the art will understand that during synthesis of the preferred embodiment depicted pictorially for formula (IV) will result in a mixture comprising the hydrophobically modified polyamine depicted pictorially in formula (IV) with all nitrogens quaternized with benzyl groups and a hydrophobically modified polyamines with unreacted lone pairs of electrons on nitrogens thereby resulting in a 90% by Q moiety quaternization with benzyl groups.

Surfactant System

The laundry detergent compositions of the present invention comprise from about 0.01%, preferably from about 1%, more preferably from about 5%, most preferably from 10% to about 80%, preferably to about 50%, more preferably to about 30%, by weight of a surfactant system, said surfactant system comprising one or more surfactants selected from:

i) from 0% to 100% by weight, of one or more anionic surfactants;

preferably between 0.01% and 80% by weight of one or more anionic surfactants;

ii) from 0% to 100% by weight, of one or more nonionic surfactants;

preferably between 0% and 84% by weight of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof.

Depending upon the embodiment of the present invention one or more categories of surfactants may be chosen by the formulator. Within each category of surfactant, more than one type of surfactant can be selected.

Anionic Surfactants

Nonlimiting examples of anionic surfactants useful herein include:

a) C₁₁-C₁₈ alkyl benzene sulfonates (LAS);

b) C₁₀-C₂₀ primary, branched-chain and random alkyl sulfates (AS);

c) C₁₀-C₁₈ secondary (2,3) alkyl sulfates having formulae (X) and (XI):

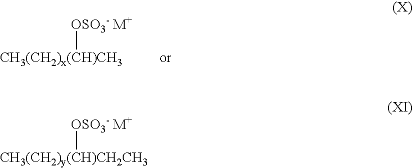

M in formulae (X) and (XI) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x in formulae (X) and (XI) is an integer of at least about 7, preferably at least about 9; y in formulae (X) and (XI) is an integer of at least 8, preferably at least about 9;

d) C₁₀-C₁₈ alkyl alkoxy sulfates (AE_{X}S) wherein preferably x is from 1-30;

e) C₁₀-C₁₈ alkyl alkoxy carboxylates preferably comprising 1-5 ethoxy units;

f) mid-chain branched alkyl sulfates having formula (XII):

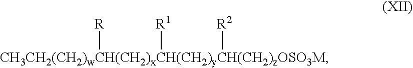

g) alkyl alkoxy sulfates have formula (XIII):

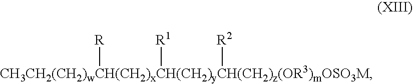

wherein for both the mid-chain branched alkyl sulfates and the alkyl alkoxy sulfates R, R¹, and R² in formulae (XII) and (XIII) are each independently hydrogen, C₁-C₃ alkyl, and mixtures thereof; provided at least one of R, R¹, and R² in formulae (XII) and (XIII) is not hydrogen; preferably R, R¹, and R² in formulae (XII) and (XIII) are methyl; preferably one of R, R¹, and R² in formulae (XII) and (XIII) is methyl and the other units are hydrogen. The total number of carbon atoms in the mid-chain branched alkyl sulfate and alkyl alkoxy sulfate surfactants is from 14 to 20; the index w in formulae (XII) and (XIII) is an integer from 0 to 13; x in formulae (XII) and (XIII) is an integer from 0 to 13; y in formulae (XII) and (XIII) is an integer from 0 to 13; z in formulae (XII) and (XIII) is an integer of at least 1; provided w+x+y+z is from 8 to 14 and the total number of carbon atoms in a surfactant is from 14 to 20; R in formula (XIII) is C₁-C₄ linear or branched alkylene, preferably ethylene, 1,2-propylene, 1,3-propylene, 1,2-butylene, 1,4-butylene, and mixtures thereof. However, a preferred embodiment of the present invention comprises from 1 to 3 units wherein R³ in formula (XIII) is 1,2-propylene, 1,3-propylene, or mixtures thereof followed by the balance of the R³ units in formula (XIII) comprising ethylene units. Another preferred embodiment comprises R³ units in formula (XIII) that are randomly ethylene and 1,2-propylene units. The average value of the index m in formula (XIII) is at least about 0.01. When the index m in formula (XIII) has low values, the surfactant system comprises mostly alkyl sulfates with a small amount of alkyl alkoxy sulfate surfactant. Some tertiary carbon atoms may be present in the alkyl chain, however this embodiment is not desired.

M in formulae (XII) and (XIII) denotes a cation, preferably hydrogen, a water soluble cation, and mixtures thereof. Non-limiting examples of water soluble cations include sodium, potassium, lithium, ammonium, alkyl ammonium, and mixtures thereof.

The preferred mid-chain branched alkyl sulfate and alkyl alkoxy sulfate surfactants of the present invention are “substantially linear” surfactants. The term “substantially linear” is defined for the purposes of the present invention as “alkyl units which comprise one branching unit or the chemical reaction products which comprise mixtures of linear (non-branched) alkyl units and alkyl units which comprise one branching unit”. The term “chemical reaction products” refers to the admixture obtained by a process wherein substantially linear alkyl units are the desired product but nevertheless some non-branched alkyl units are formed. When this definition is taken together with preferably one of R, R¹, and R² in formulae (XII) and (XIII) is methyl and the other units are hydrogen, the preferred mid-chain branched alkyl sulfate and alkyl alkoxy sulfate surfactants comprise one methyl branch, preferably said methyl branch is not on the α, β, or the second to the last carbon atom. Typically the branched chains are a mixture of isomers.

The following illustrate preferred examples of mid-chain branched alkyl sulfate and alkoxy alkyl sulfate surfactants.

Formula (XIV) 8-Methylundecyl sulfate:

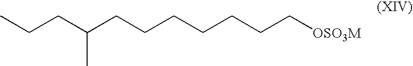

Formula (XV) 3-Methylundecyl sulfate:

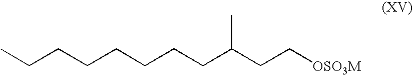

Formula (XVI) 3-Methyltridecyl sulfate:

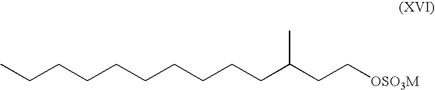

Formula (XVII) 8-Methyltridecyl sulfate:

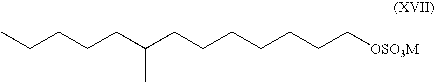

h) mid-chain branched aryl sulphonates having formula (XVIII):

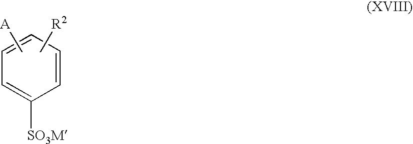

wherein A in formula (XVIII) is a mid-chain branched alkyl unit having formula (XIX):

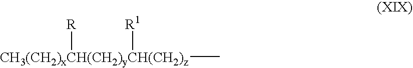

wherein R and R¹ in formula (XIX) are each independently hydrogen, C₁-C₃ alkyl, and mixtures thereof, provided at least one of R and R¹ in formula (XIX) is not hydrogen; preferably at least one R or R¹ in formula (XIX) is methyl; wherein the total number of carbon atoms in said alkyl unit is from 6 to 18. Some tertiary carbon atoms may be present in the alkyl chain, however, this embodiment is not desired.

The integer x in formula (XIX) is from 0 to 13. The integer y in formula (XIX) is from 0 to 13. The integer z in formula (XIX) is either 0 or 1, preferably 0.

R² in formula (XVIII) is hydrogen, C₁-C₃ alkyl, and mixtures thereof. Preferably R² in formula (XVIII) is hydrogen.

M′ in formula (XVIII) denotes a water soluble cation with sufficient charge to provide neutrality, preferably hydrogen, a water soluble cation, and mixtures thereof. Non-limiting examples of water soluble cations include sodium, potassium, lithium, ammonium, alkyl ammonium, and mixtures thereof.

In one embodiment of the present invention mid-chain branched aryl sulphonate surfactants are “substantially linear aryl” surfactants. The term “substantially linear aryl” is defined for the purposes of the present invention as “an alkyl unit which is taken together with an aryl unit wherein said alkyl unit preferably comprises one branching unit, however, a non-branched linear alkyl unit having an aryl unit bonded to the 2-carbon position as part of an admixture is included as a substantially linear aryl surfactant”. The preferred alkyl units do not have a methyl branch on the second to the last carbon atom. Typically the branched chains are a mixture of isomers. However, in the case of the mid-chained branched aryl sulphonates of the present invention, the relative position of the aryl moiety is key to the functionality of the surfactant. Preferably the aryl moiety is attached to the second carbon atom in the branched chain as illustrated herein below.

In one or more embodiments mid-chain branched aryl sulphonates of the present invention will comprise a mixture of branched chains. Preferably R¹ in formula (XIX) is methyl, the index z in formula (XIX) is equal to 0, and the sulphate moiety is para (1,4) to the branched alkyl substituent thereby resulting in a “2-phenyl aryl sulphonate” defined herein by the general formula (XX):

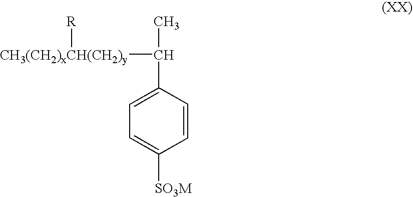

wherein x and y in formula (XX) are the same as described in formula (XIX).

Typically 2-phenyl aryl sulphonates are formed as a mixture together with “3-phenyl aryl sulphonates” defined herein by the general formula (XXI):

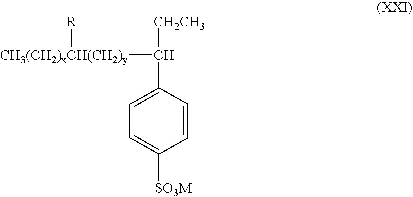

wherein x and y in formula (XXI) are the same as described in formula (XIX).

The surfactant properties of the mid-chain branched aryl sulphonates of the present invention can be modified by varying the ratio of 2-phenyl to 3-phenyl isomers in the final surfactant mixture. A convenient means for describing the relative amounts of isomers present is the “⅔ phenyl index” defined herein as “100 times the quotient of the amount of 2-phenyl isomer present divided by the amount of the 3-phenyl isomer which is present”. Any convenient means, NMR, inter alia, can be used to determine the relative amounts of isomers present. A preferred ⅔ phenyl index is at least about 275 which corresponds to at least 2.75 times more 2-phenyl isomer present than the 3-phenyl isomer in the surfactant mixture. The preferred ⅔-phenyl index according to the present invention is from about 275, more preferably from about 350, most preferably from about 500 to about 10,000, preferably to about 1200, more preferably to about 700.

Those of ordinary skill in the art will recognize that the mid-chain branched surfactants of the present invention will be a mixture of isomers and the composition of the mixture will vary depending upon the process which is selected by the formulator to make the surfactants. For example, the following admixture is considered to comprise a substantially linear mid-chain branched aryl sulphonate admixture according to the present invention. Sodium para-(7-methylnonan-2-yl)benzenesulphonate, sodium para-(6-methylnonan-2-yl)benzenesulphonate, sodium para-(7-methylnonan-3-yl)benzene-sulphonate, sodium para-(7-methyldecan-2-yl)benzenesulphonate, sodium para-(7-methylnonanyl)benzenesulphonate.

Another preferred surfactant system according to the present invention comprises from about 0.01% by weight of a high nonionic surfactant system comprising:

i) from about 85% to about 99.9% by weight, of one or more nonionic surfactants;

ii) optionally, from about 0.1% to about 15% by weight, of one or more anionic surfactants;

iii) optionally from about 0.1% to about 15% by weight, of one or more cationic surfactants;

iv) optionally from about 0.1% to about 15% by weight, of one or more zwitterionic surfactants;

v) optionally from about 0.1% to about 15% by weight, of one or more ampholytic surfactants; or

vi) mixtures thereof.

Non-limiting examples of nonionic surfactants according to the present invention include:

i) C₁₂-C₁₈ alkyl ethoxylates, inter alia, NEODOL® nonionic surfactants ex Shell;

ii) C₆-C₁₂ alkyl phenol alkoxylates wherein the alkoxylate units are a mixture of ethyleneoxy and propyleneoxy units;

iii) C₁₂-C₁₈ alcohol and C₆-C₁₂ alkyl phenol condensates with ethylene oxide/propylene oxide block polymers inter alia Pluronic® ex BASF;

iv) C₁₄-C₂₂ mid-chain branched alcohols, BA, having formula (XXII):

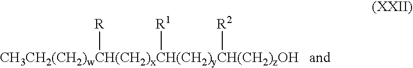

v) C₁₄-C₂₂ mid-chain branched alkyl alkoxylates, BAEₓ, having formula (XXIII):

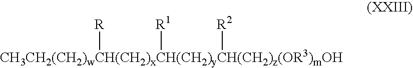

wherein R, R¹, and R² in formulae (XXII) and (XXIII) are each independently hydrogen, C₁-C₃ alkyl, and mixtures thereof; provided at least one of R, R¹, and R² in formulae (XXII) and (XXIII) is not hydrogen; preferably R, R¹, and R² in formulae (XXII) and (XXIII) are methyl; preferably one of R, R¹, and R² in formulae (XXII) and (XXIII) is methyl and the other units are hydrogen. The total number of carbon atoms in the mid-chain branched alkyl sulfate and alkyl alkoxy sulfate surfactants is from 14 to 20; the index w in formulae (XXII) and (XXIII) is an integer from 0 to 13; x in formulae (XXII) and (XXIII) is an integer from 0 to 13; y in formulae (XXII) and (XXIII) is an integer from 0 to 13; z in formulae (XXII) and (XXIII) is an integer of at least 1; provided w+x+y+z is from 8 to 14 and the total number of carbon atoms in a surfactant is from 14 to 20; R³ in formula (XXIII) is C₁-C₄ linear or branched alkylene, preferably ethylene, 1,2-propylene, 1,3-propylene, 1,2-butylene, 1,4-butylene, and mixtures thereof; and the average value of the index m in formula (XXIII) is at least about 0.01. When the index m in formula (XXIII) has low values, the surfactant system comprises mostly alkyl sulfates with a small amount of alkyl alkoxy sulfate surfactant.

vi) Alkylpolysaccharides as disclosed in U.S. Pat. No. 4,565,647 Llenado, issued Jan. 26, 1986;

vii) Polyhydroxy fatty acid amides having formula (XXIV):

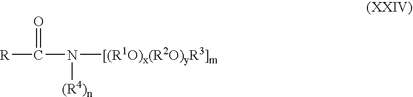

wherein R in formula (XXIV) is C₇-C₂₁ linear alkyl, C₇-C₂₁ branched alkyl, C₇-C₂₁ linear alkenyl, C₇-C₂₁ branched alkenyl, and mixtures thereof.

R¹ in formula (XXIV) is ethylene; R² in formula (XXIV) is C₃-C₄ linear alkyl, C₃-C₄ branched alkyl, and mixtures thereof; preferably R² in formula (XXIV) is 1,2-propylene. Nonionic surfactants that comprise a mixture of R¹ and R² units in formula (XXIV) preferably comprise from about 4 to about 12 ethylene units in combination with from about 1 to about 4 1,2-propylene units. The units may be alternating, or grouped together in any combination suitable to the formulator. Preferably the ratio of R¹ units to R² units in formula (XXIV) is from about 4:1 to about 8:1. Preferably an R² unit in formula (XXIV) (i.e., 1,2-propylene) is attached to the nitrogen atom followed by the balance of the chain comprising from 4 to 8 ethylene units.

R³ in formula (XXIV) is hydrogen, C₁-C₄ linear alkyl, C₃-C₄ branched alkyl, and mixtures thereof; preferably hydrogen or methyl, more preferably hydrogen.

R⁴ in formula (XXIV) is hydrogen, C₁-C₄ linear alkyl, C₃-C₄ branched alkyl, and mixtures thereof; preferably hydrogen. When the index m in formula (XXIV) is equal to 2 the index n in formula (XXIV) must be equal to 0 and the R⁴ unit in formula (XXIV) is absent and is instead replaced by a —[(R¹O)ₓ(R²O)_{y}R³] unit.

The index m in formula (XXIV) is 1 or 2, the index n in formula (XXIV) is 0 or 1, provided that when m in formula (XXIV) is equal to 1, n in formula (XXIV) is equal to 1; and when m in formula (XXIV) is 2 n in formula (XXIV) is 0; preferably m in formula (XXIV) is equal to 1 and n in formula (XXIV) is equal to one, resulting in one —[(R¹O)ₓ(R²O)_{y}R³] unit and R⁴ in formula (XXIV) being present on the nitrogen. The index x in formula (XXIV) is from 0 to about 50, preferably from about 3 to about 25, more preferably from about 3 to about 10. The index y in formula (XXIV) is from 0 to about 10, preferably 0, however when the index y in formula (XXIV) is not equal to 0, y in formula (XXIV) is from 1 to about 4. Preferably all of the alkyleneoxy units are ethyleneoxy units. Those skilled in the art of ethoxylated polyoxyalkylene alkyl amide surface active agents will recognized that the values for the indices x and y in formula (XXIV) are average values and the true values may range over several values depending upon the process used to alkoxylate the amides.

Adjunct Materials

While not essential for the purposes of the present invention, the non-limiting list of adjuncts illustrated hereinafter are suitable for use in the instant cleaning compositions and may be desirably incorporated in preferred embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Surfactants—Preferably, the cleaning compositions according to the present invention comprise a surfactant or surfactant system wherein the surfactant can be selected from nonionic and/or anionic and/or cationic surfactants and/or ampholytic and/or zwitterionic and/or semi-polar nonionic surfactants.

The surfactant is typically present at a level of from about 0.1%, preferably about 1%, more preferably about 5% by weight of the cleaning compositions to about 99.9%, preferably about 80%, more preferably about 35%, most preferably 30% about by weight of the cleaning compositions.

Builders—The cleaning compositions of the present invention preferably comprise one or more detergent builders or builder systems. When present, the compositions will typically comprise at least about 1% builder, preferably from about 5%, more preferably from about 10% to about 80%, preferably to about 50%, more preferably to about 30% by weight, of detergent builder.

Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The cleaning compositions herein may also optionally contain one or more copper, iron and/or manganese chelating agents.

If utilized, these chelating agents will generally comprise from about 0.1% by weight of the cleaning compositions herein to about 15%, more preferably 3.0% by weight of the cleaning compositions herein.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in the cleaning compositions herein, the dye transfer inhibiting agents are present at levels from about 0.0001%, more preferably about 0.01%, most preferably about 0.05% by weight of the cleaning compositions to about 10%, more preferably about 2%, most preferably about 1% by weight of the cleaning compositions.

Dispersants—The cleaning compositions of the present invention can also contain dispersants. Suitable water-soluble organic salts are the homo- or co-polymeric acids or their salts, in which the polycarboxylic acid comprises at least two carboxyl radicals separated from each other by not more than two carbon atoms.

Enzymes—The cleaning compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or mixtures thereof. A preferred combination is a cleaning composition having a cocktail of conventional applicable enzymes like protease, lipase, cutinase and/or cellulase in conjunction with the amylase of the present invention.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243 Bragg, issued Feb. 2, 1982.

If desired, the compositions herein can be catalyzed by means of a manganese compound. Such compounds and levels of use are well known in the art and include, for example, the manganese-based catalysts disclosed in U.S. Pat. No. 5,576,282 Miracle et al. Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl- 1,4,7-triazacyclononane)₂(ClO₄)₂, Mn^{IV}₄(u-O)₆(1,4,7-triazacyclononane)₄(ClO₄)₄, Mn^{III-}Mn^{IV}₄(u-O)₁(u-OAc)₂₋(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof.

Cobalt bleach catalysts useful herein are known, and are described, for example, in U.S. Pat. No. 5,597,936 Perkins et al., issued Jan. 28, 1997; U.S. Pat. No. 5,595,967 Miracle et al., Jan. 21, 1997. The most preferred cobalt catalyst useful herein are cobalt pentaamine acetate salts having the formula [Co(NH₃)₅OAc] T_{y}, wherein “OAc” represents an acetate moiety and “T_{y}” is an anion, and especially cobalt pentaamine acetate chloride, [Co(NH₃)₅OAc]Cl₂; as well as [Co(NH₃)₅OAc](OAc)₂; [Co(NH₃)₅OAc](PF₆)₂; [Co(NH₃)₅OAc](SO₄); [Co(NH₃)₅OAc](BF₄)₂; and [Co(NH₃)₅OAc](NO₃)₂ (herein “PAC”). Such cobalt catalysts are readily prepared by known procedures, such as taught for example in U.S. Pat. No. 5,597,936, and U.S. Pat. No. 5,595,967.

Compositions herein may also suitably include a transition metal complex of a macropolycyclic rigid ligand—abreviated as “MRL”. As a practical matter, and not by way of limitation, the compositions and cleaning processes herein can be adjusted to provide on the order of at least one part per hundred million of the active MRL species in the aqueous washing medium, and will preferably provide from about 0.005 ppm to about 25 ppm, more preferably from about 0.05 ppm to about 10 ppm, and most preferably from about 0.1 ppm to about 5 ppm, of the MRL in the wash liquor.

Suitable metals in the MRLs include Mn(II), Mn(III), Mn(IV), Mn(V), Fe(II), Fe(III), Fe(IV), Co(I), Co(II), Co(III), Ni(I), Ni(II), Ni(III), Cu(I), Cu(II), Cu(III), Cr(II), Cr(III), Cr(IV), Cr(V), Cr(VI), V(III), V(IV), V(V), Mo(IV), Mo(V), Mo(VI), W(IV), W(V), W(VI), Pd(II), Ru(II), Ru(III), and Ru(IV). Preferred transition-metals in the instant transition-metal bleach catalyst include manganese, iron and chromium. Suitable MRL's herein comprise:

(a) at least one macrocycle main ring comprising four or more heteroatoms; and

(b) a covalently connected non-metal superstructure capable of increasing the rigidity of the macrocycle, preferably selected from

(i) a bridging superstructure, such as a linking moiety;

(ii) a cross-bridging superstructure, such as a cross-bridging linking moiety; and

(iii) combinations thereof.

Preferred MRL's herein are a special type of ultra-rigid ligand that is cross-bridged. A “cross-bridge” is non-limitingly illustrated in FIG. 1 herein below. FIG. 1 illustrates a cross-bridged, substituted (all nitrogen atoms tertiary) derivative of cyclam. The cross-bridge is a —CH₂CH₂— moiety that bridges N¹ and N⁸.

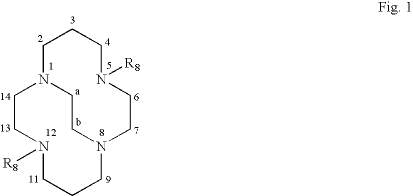

When each R₈ is ethyl, this ligand is named, 5,12-diethyl-1,5,8,12-tetraazabicyclo[6.6.2]hexadecane.

Transition-metal bleach catalysts of MRLs that are suitable for use in Applicants' cleaning compositions are non-limitingly illustrated by any of the following:

Dichloro-5,12-diethyl-1,5,8,12-tetraazabicyclo[6.6.2]hexadecane Manganese(II)

Diaquo-5,12-diethyl-1,5,8,12-tetraazabicyclo[6.6.2]hexadecane Manganese(II) Hexafluorophosphate

Aquo-hydroxy-5,12-diethyl-1,5,8,12-tetraazabicyclo[6.6.2]hexadecane Manganese(III) Hexafluorophosphate

Diaquo-5,12-diethyl-1,5,8,12-tetraazabicyclo[6.6.2]hexadecane Manganese(II) Tetrafluoroborate

Dichloro-5,12-diethyl-1,5,8,12-tetraazabicyclo[6.6.2]hexadecane Manganese(III) Hexafluorophosphate

Dichloro-5,12-di-n-butyl-1,5,8,12-tetraaza bicyclo[6.6.2]hexadecane Manganese(II)

Dichloro-5,12-dibenzyl-1,5,8,12-tetraazabicyclo[6.6.2]hexadecane Manganese(II)

Dichloro-5-n-butyl-12-methyl-1,5,8,12-tetraaza-bicyclo[6.6.2]hexadecane Manganese(II)

Dichloro-5-n-octyl-12-methyl-1,5,8,12-tetraaza-bicyclo[6.6.2]hexadecane Manganese(II)

Dichloro-5-n-butyl-12-methyl-1,5,8,12-tetraaza-bicyclo[6.6.2]hexadecane Manganese(II).

Suitable transition metal MRLs are readily prepared by known procedures, such as taught for example in WO 00/332601, and U.S. Pat. No. 6,225,464.

### EXAMPLE 1

Hydrophobically Modified Polyamine Derived from Bis(Hexamethylene)-triamine Containing 100 Moles of Ethylene Oxide (20 per NH), Average of Two Benzyl Groups, and Average of One Sulfate Group Per Molecule.

a) Ethoxylation of Bis(hexamethylene)triamine to average of 20 Ethylene oxide units per NH—The ethoxylation is conducted in a 2 gallon stirred stainless steel autoclave equipped for temperature measurement and control, pressure measurement, vacuum and inert gas purging, sampling, and for introduction of ethylene oxide as a liquid. A approximately 9.07 kg (20 lb.) net cylinder of ethylene oxide (ARC) is set up to deliver ethylene oxide as a liquid by a pump to the autoclave with the cylinder placed on a scale so that the weight change of the cylinder can be monitored.

A 362 g portion of Bis(hexamethylene)triamine (BHMT) (m.w. 215, 1.68 moles, 5.04 moles nitrogen, 8.4 moles ethoxylatable (NH) sites), is added to the autoclave. The autoclave is then sealed and purged of air (by applying vacuum to minus 94.8 Mpa (minus 28 inches Hg) followed by pressurization with nitrogen to 1.62 MPa (250 psia), then venting to atmospheric pressure). The autoclave contents are heated to 80° C. while applying vacuum. After about one hour, the autoclave is charged with nitrogen to about 1.62 MPa (250 psia) while cooling the autoclave to about 105° C. Ethylene oxide is then added to the autoclave incrementally over time while closely monitoring the autoclave pressure, temperature, and ethylene oxide flow rate. The ethylene oxide pump is turned off and cooling is applied to limit any temperature increase resulting from any reaction exotherm. The temperature is maintained between 100° C. and 110° C. while the total pressure is allowed to gradually increase during the course of the reaction. After a total of 370 grams of ethylene oxide (8.4 moles) has been charged to the autoclave, the temperature is increased to 110° C. and the autoclave is allowed to stir for an additional 2 hours. At this point, vacuum is applied to remove any residual unreacted ethylene oxide.

Next, vacuum is continuously applied while the autoclave is cooled to about 50° C. while introducing 181.5 g of a 25% sodium methoxide in methanol solution (0.84 moles, to achieve a 10% catalyst loading based upon ethoxylatable sites functions). The methanol is removed from the autoclave under vacuum and then the autoclave temperature controller setpoint is increased to 100° C. A device is used to monitor the power consumed by the agitator. The agitator power is monitored along with the temperature and pressure. Agitator power and temperature values gradually increase as methanol is removed from the autoclave and the viscosity of the mixture increases and stabilizes in about 1.5 hours indicating that most of the methanol has been removed. The mixture is further heated and agitated under vacuum for an additional 30 minutes.

Vacuum is removed and the autoclave is cooled to 105° C. while it is being charged with nitrogen to 1.62 MPa (250 psia) and then vented to ambient pressure. The autoclave is charged to 1.28 MPa (200 psia) with nitrogen. Ethylene oxide is again added to the autoclave incrementally as before while closely monitoring the autoclave pressure, temperature, and ethylene oxide flow rate while maintaining the temperature between 100° C. and 110° C. and limiting any temperature increases due to reaction exotherm. After the addition of 4180 g of ethylene oxide (95 mol, resulting in a total of 20 moles of ethylene oxide per mole of ethoxylatable sites on BHMT), the temperature is increased to 110° C. and the mixture stirred for an additional 2 hours.

The reaction mixture is then collected into a 22 L three neck round bottomed flask purged with nitrogen. The strong alkali catalyst is neutralized by slow addition of 80.7 g methanesulfonic acid (0.84 moles) with heating (100° C.) and mechanical stirring. The reaction mixture is then removed of residual ethylene oxide and deodorized by sparging an inert gas (argon or nitrogen) into the mixture through a gas dispersion frit while agitating and heating the mixture to 120° C. for 1 hour. The final reaction product is cooled slightly and stored in a glass container purged with nitrogen.

b. Quaternization of BHMT E20 with 2 equivalents of benzyl bromide (3 mol N per mol polymer)—Into a weighed, 1000 ml, 3 neck round bottom flask fitted with argon inlet, condenser, addition funnel, thermometer, mechanical stirring and argon outlet (connected to a bubbler) is added BHMT E020 (522.8g, 0.111 mol polymer, 0.333 mol N, 98% active, m.w.−4615) under argon. The material is heated to 80° C. with stirring until melted. Next, benzyl bromide (37.6g, 0.220 mol, m.w. 171.04) is slowly added to the melted BHMT E020 using an addition funnel over a period of 10 minutes. The reaction is complete after stirring at 80° C. for 6 hours. By NMR, the amine groups are 64% quated (i.e., approximately 2 out of 3 nitrogens on average are quated)

c. Sulfation (1 equivalent) of BHMT E20 dibenzyl monomethyl quaternary ammonium salt—Under argon, the reaction mixture from the quaternization step is dissolved in 1 L of methylene chloride and is cooled to 5° C. to 10° C. using an ice bath (BHMT E20, 90+mol % quat, 0.111 mole, 0.555 mol OH). Chlorosulfonic acid (12.9 g, 0.111 mol, 99%, mw-116.52) is slowly added using an addition funnel at such a rate the temperature of the reaction mixture does not exceed 10° C. The ice bath is removed and the reaction is allowed to rise to room temperature (23° C.). After 6 hours the reaction is complete. The reaction is again cooled to 5° C. to 10° C. and sodium methoxide (48 g, 0.222 mol, 25% in methanol, m.w. 54.02) is slowly added to the rapidly stirred mixture. The temperature of the reaction mixture is not allowed to rise above 10° C. The reaction mixture is transferred to a single neck round bottom flask. Purified water (1300 ml) is added to the reaction mixture and the methylene chloride, methanol and some water is stripped off on a rotary evaporator at 50° C. The clear, light yellow solution (About 30-40% hydrophobically modified polyamine in water) is transferred to a bottle for storage. The final product pH is checked and adjusted to approximately 8 to 9 using 1N NaOH or 1N HCl as needed. By NMR, 19% of the terminal hydroxyl groups of the ethoxylate chains are sulfated.

### Synthesis Example 2

Hydrophobically Modified Polyamine Derived from Bis(Hexamethylene)-triamine Containing 100 Moles of Ethylene Oxide (20 per NH), Average of Two Benzyl Groups, and Average of Five Sulfate Groups Per Molecule.

a. Quaternization Of Example 1b With Dimethyl Sulfate—Under argon, the BHMT E20 dibenzyl quaternary ammonium salt prepared exactly as in Example 1b is dissolved in 1 L of methylene chloride and then chilled to 5° C. to 10° C. using an ice bath. With good mixing, dimethyl sulfate (14.2 g, 0.113 mol, 99+%, mw 126.1) is dripped in from an addition funnel at such a rate the temperature of the reaction mixture does not exceed 10° C. The ice bath is removed and the reaction is allowed to mix at room temperature (23° C.) for 2-3 hours at which point the reaction is complete. By NMR, the amine groups are 90% quaternized.

b. 90+% Sulfation of 2a—Under argon, the reaction mixture from the quaternization step, 2a, is dissolved in 1 L of methylene chloride and is cooled to 5° C. to 10° C. using an ice bath (BHMT E20, 90+mol % quat, 0.555 mol OH). Chlorosulfonic acid (64.7 g, 0.555 mol, 99%, mw 116.52) is slowly added using an addition funnel at such a rate the temperature of the reaction mixture does not exceed 10° C. The ice bath is removed and the reaction is allowed to rise to room temperature. After 6 hours the reaction is complete. The reaction is again cooled to 5° C. to 10° C. and sodium methoxide (240 g, 1.11 mol, 25% in methanol, m.w.−54.02) is slowly added to the rapidly stirred mixture. The temperature of the reaction mixture is not allowed to rise above 10° C. The reaction mixture is transferred to a single neck round bottom flask. Purified water (1300 ml) is added to the reaction mixture and the methylene chloride, methanol and some water is stripped off on a rotary evaporator at 50° C. The clear, light yellow aqueous solution is transferred to a bottle for storage. The final product pH is checked and adjusted to approximately 8 to 9 using 1N NaOH or 1N HCl as needed. By NMR, 94% of the terminal hydroxyl groups of the ethoxylate chains are sulfated.

### Synthesis Example 3

Hydrophobically Modified Polyamine Derived from Bis(Hexamethylene)-triamine Containing 100 Moles of Ethylene Oxide (20 per NH), Average of Three Benzyl Groups, and Average of One Sulfate Group Per Molecule.

a. Quaternization of 1a)—Into a weighed, 1000 ml, 3 neck round bottom flask fitted with argon inlet, condenser, addition funnel, thermometer, mechanical stirring and argon outlet (connected to a bubbler) is added BHMT E020 as prepared in example 1a (522.8 g, 0.333 mol N, 98% active, m.w. 4615) under argon. The material is heated to 80° C. with stirring until melted. Next, benzyl bromide (59.9 g, 0.35 mol, m.w. 171.04) is slowly added to the melted BHMT E020 using an addition funnel over a period of 10 minutes. The reaction is complete after stirring at 80° C. for 6 hours. By NMR, the amine groups are 91% quated.

b. 20% Sulfation of 3a—Under argon, the reaction mixture from the quaternization step, 3a, is dissolved in 1 L of methylene chloride and then cooled to 5° C. to 10° C. using an ice bath (BHMT E20, 90+mol % quat, 0.555 mol OH). Chlorosulfonic acid (12.9 g, 0.111 mol, 99%, m.w. 116.52) is slowly added using an addition funnel at such a rate the temperature of the reaction mixture does not exceed 10° C. The ice bath is removed and the reaction is allowed to rise to room temperature. After 6 hours the reaction is complete. The reaction is again cooled to 5° to 10° C. and sodium methoxide (48 g, 0.222 mol, 25% in methanol, m.w. 54.02) is slowly added to the rapidly stirred mixture. The temperature of the reaction mixture is not allowed to rise above 10° C. The reaction mixture is transferred to a single neck round bottom flask. Purified water (1300 ml) is added to the reaction mixture and the methylene chloride, methanol and some water is stripped off on a rotary evaporator at 50° C. The clear, light yellow solution is transferred to a bottle for storage. The final product pH is checked and adjusted to approximately 8 to 9 using 1N NaOH or 1N HCl as needed. By NMR, 20% of the terminal hydroxyl groups of the ethoxylate chains are sulfated.

### EXAMPLE 4

Hydrophobically Modified Polyamine Derived from Bis(Hexamethylene)-triamine Containing 100 Moles of Ethylene Oxide (20 per NH), Average of Three Benzyl Groups, and Average of Five Sulfates Group Per Molecule.

a. 90+% Sulfation of example 3a—Under argon, the BHMT E20 tribenzyl quaternary ammonium salt prepared exactly as in Example 3a is dissolved in 1 L of methylene chloride and then cooled to 5° C. to 10° C. using an ice bath (BHMT E20, 90+mol % quat, 0.555 mol OH). Chlorosulfonic acid (64.7 g, 0.555 mol, 99%, m.w. 116.52) is slowly added using an addition funnel at such a rate the temperature of the reaction mixture does not exceed 10° C. The ice bath is removed and the reaction is allowed to rise to room temperature. After 6 hours the reaction is complete. The reaction is again cooled to 5° C. to 10° C. and sodium methoxide (240 g, 1.11 mol, 25% in methanol, m.w. 54.02) is slowly added to the rapidly stirred mixture. The temperature of the reaction mixture is not allowed to rise above 10° C. The reaction mixture is transferred to a single neck round bottom flask. Purified water (1300 ml) is added to the reaction mixture and the methylene chloride, methanol and some water is stripped off on a rotary evaporator at 50° C. The clear, light yellow solution is transferred to a bottle for storage. The final product pH is checked and adjusted to approximately 8 to 9 using 1N NaOH or 1N HCl as needed. Mixture is not allowed to rise above 10° C. The ice bath is removed and the reaction is allowed to rise to room temperature. After 6 hours the reaction is complete. The reaction is again cooled to 5° C. and sodium methoxide (264 g, 1.22 mol, 25% in methanol, m.w. 54.02) is slowly added to the rapidly stirred mixture. The temperature of the reaction mixture is not allowed to rise above 10° C. The reaction mixture is transferred to a single neck round bottom flask. Purified water (1300 ml) is added to the reaction mixture and the methylene chloride, methanol and some water is stripped off on a rotary evaporator at 50° C. The clear, light yellow solution is transferred to a bottle for storage. The final product pH is checked and adjusted to approximately 9 using 1N NaOH or 1N HCl as needed. By NMR, 93% of the terminal hydroxyl groups of the ethoxylate chains are sulfated.

Method of Use

The present invention further relates to a method for removing hydrophobic soils, inter alia, body oils, perspiration and other human body soils form fabric, preferably clothing, said method comprising the step of contacting fabric in need of cleaning with an aqueous solution containing at least 0.01% by weight, of a laundry detergent composition comprising:

A) from about 0.01% to about 50% by weight of a hydrophobically modified polyamine having formula (I):

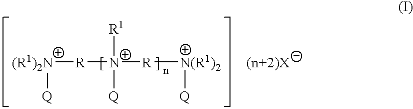

wherein R in formula (I) is C₅-C₂₀ linear or branched alkylene, and mixtures thereof; R¹ in formula (I) is an alkyleneoxy unit having formula (II):

—(R²O)ₓ—R³ (II)

wherein R² in formula (II) is C₂-C₄ linear or branched alkylene, and mixtures thereof; R³ in formula (II) is at least one anionic unit selected from the group comprising:

i) —(CH₂)_{f}CO₂⁻;

ii) —C(O)(CH₂)_{f}CO₂⁻;

iii) —(CH₂)_{f}PO₃²⁻;

iv) —(CH₂)_{f}OPO₃²⁻;

v) —(CH₂)_{f}SO₃⁻;

vi) —CH₂(CHSO₃⁻)(CH₂)_{f}SO₃⁻;

vii) —CH₂(CHSO₂⁻)(CH₂)_{f}SO₃⁻;

viii) —C(O)CH₂CH(SO₃⁻)CO₂⁻;

ix) —C(O)CH₂CH(CO₂⁻)NHCH(CO₂⁻)CH₂CO₂⁻;

x) —CH₂CH(OH)CH₂SO₃⁻;

xi) —CH₂CH(SO₃⁻)CH₂OH;

xii) —CH₂PhSO₃⁻;

xiii) —PhSo₃⁻;

xiv) and mixtures thereof;

wherein the index f in the anionic capping units is from 0 to about 10; x in formula (II) is from about 15 to about 30; with the remaining R³ moieties in formula (II) selected from the group comprising hydrogen, C₁-C₂₂ alkylenearyl, the anionic capping units above, a neutral capping unit, and mixtures thereof; wherein at least one Q moiety, but less than all Q moieties in formula (I) are hydrophobic quaternizing units selected from the group comprising C₇-C₃₀ substituted or unsubstituted alkylenearyl, and mixtures thereof, with the remaining Q moieties in formula (I) selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof; X in formula (I) is an anion present in sufficient amount to provide electronic neutrality; n in formula (I) is from 0 to 4;

B) from about 0.01% to about 60% by weight, of a surfactant system comprising one or more surfactants selected from:

i) from 0% to 100% by weight, of one or more anionic surfactants;

ii) from 0% to 100% by weight, of one or more nonionic surfactants;

iii) optionally from 0.1% to about 80% by weight, of one or more cationic surfactants;

iv) optionally from 0.1% to about 80% by weight, of one or more zwitterionic surfactants;

v) optionally from 0.1% to about 80% by weight, of one or more ampholytic surfactants; or

vi) mixtures thereof;

C) the balance carriers and adjunct ingredients.

Preferably the aqueous solution comprises at least about 0.01% (100 ppm), preferably at least about 1% (1000 ppm) by weight, of said laundry detergent composition.

Processes of Making and Using of Applicants' Cleaning Composition

The present invention when incorporated into cleaning compositions can be formulated into any suitable form and prepared by any process known in the art chosen by the formulator.

The following are non-limiting examples of the compositions according to the present invention.

TABLE I

| | weight % | | | |
|---|---|---|---|---|
| Ingredients | 2 | 3 | 4 | 5 |
| C₁₄—C₁₅ alkyl E1.0 sulfate | 12.3 | — | — | 22.5 |
| Linear alkyl benzene sulfonate | 5.4 | 12.2 | 15.0 | 3.0 |
| C_{8—10} amidopropyl amine | — | — | 1.4 | 1.5 |
| Alkyldimethyl amine oxide | — | 1.46 | — | — |
| C_{12—}C₁₄ alkyl E7.0 | 2.2 | 8.36 | 8.4 | 3.0 |
| Citric Acid | 4.0 | 3.42 | 1.0 | 2.5 |
| C_{12—}C₁₈ alkyl fatty acid | 2.0 | 8.29 | 10.0 | 3.5 |
| Rapeseed fatty acid | — | — | — | 5.0 |
| protease | 0.9 | 1.57 | — | 1.57 |
| amylase | 0.1 | 0.088 | — | 0.088 |
| cellulase | — | 0.027 | — | 0.055 |
| lipolase | — | 0.056 | — | — |
| mannanase | — | 0.0033 | — | 0.0033 |
| Sodium metaborate | — | 2.44 | 2.0 | 2.5 |
| Ca formate/CaCl₂ | 0.1 | 0.10 | — | 0.10 |
| Hydrophobically Modified | 0.98 | 0.98 | 0.98 | 1.5 |
| Polyamine¹ | | | | |
| Hydrophobic dispersant² | 0.65 | 0.76 | 0.48 | 0.76 |
| Soil release agent³ | 0.147 | — | — | — |
| Soil release agent⁴ | — | 0.10 | 0.10 | 0.10 |
| brightener | 0.1 | 0.05 | 0.1 | 0.1 |
| DTPA⁵ | 0.2 | 0.2 | 0.2 | 0.2 |
| Suds suppresser | 0.60 | 0.60 | 0.60 | 0.60 |
| Water and minors | balance | balance | balance | balance |

¹Hydrophobically modified polyamine according to Example 1.
²PEI 189 E15-18 according to U.S. Patent 4,597,898 Vander Meer, issued Jul. 1, 1986.
³Soil release agent according to U.S. Patent 4,702,857 Gosselink, issued Oct. 27, 1987.
⁴Soil release agent according to U.S. Patent 4,968,451, Scheibel et al., issued Nov. 6, 1990.
⁵DTPA = diethylenetriaminepentaacetic acid, sodium salt.

The following examples are non-limiting granular compositions which comprise an adjunct bleaching agent.

TABLE II

| | weight % | | | |
|---|---|---|---|---|
| Ingredients | 6 | 7 | 8 | 9 |
| Sodium C₁₁—C₁₃ alkylbenzene- | 3.15 | 18.0 | 18.0 | 8.8 |
| sulfonate | | | | |
| Sodium C₁₄—C₁₅ alcohol sulfate | 4.11 | — | — | 0.43 |
| Sodium C₁₄—C₁₅ alcohol | — | 0.8 | — | — |
| ethoxylate (0.5) sulfate | | | | |
| C16 Branched Alkyl Sulfate¹ | 9.6 | — | — | 1.0 |
| C₁₄—C₁₅ alcohol ethoxylate (6.5) | — | 0.5 | 1.4 | 3.52 |
| Quaternary Amine Surfactant² | — | 0.6 | — | — |
| Bleach activator³ | 5.28 | — | 0.75 | — |
| Sodium tripolyphosphate | — | 20.0 | 32.0 | — |
| Zeolite A, hydrate | 24.6 | — | — | 18.38 |
| (0.1-10 micron size) | | | | |
| Sodium carbonate | 21.78 | 15.26 | 9.4 | 15.38 |
| Poly(ethyleneglycol), | 0.41 | — | — | — |
| MW ˜4000 (50%) | | | | |
| CMC (Carboxymethylcellulose) | — | 0.2 | — | 0.2 |
| Sodium Polyacrylate (45%) | 1.18 | 0.5 | 0.6 | 1.1 |
| Soil release agent⁴ | — | — | — | 0.10 |
| Hydrophobically Modified | 0.5 | 0.5 | 0.6 | 1.0 |
| Polyamine⁵ | | | | |
| Sodium silicate | — | 5.79 | 6.9 | 0.13 |
| (1:6 ratio NaO/SiO₂)(46%) | | | | |
| Sodium Sulfate | — | — | 10.0 | 25.0 |
| Sodium Perborate | 1.0 | — | 3.63 | — |
| DTPA⁶ | — | 0.3 | 0.3 | — |
| Citric acid | — | — | — | — |
| Water, additives and other minors⁷ | balance | balance | balance | balance |

¹According to US 6060443 Cripe et al.
²Quaternary Amine Surfactant R₂N(CH₃)(C₂H₄OH)₂X with R₂ = C₁₂—C₁₄, X = Cl⁻.
³Nonyl ester of sodium p-hydroxybenzene-sulfonate.
⁴Soil release agent according to U.S. 5,415,807 Gosselink et al., issued May 16, 1995.
⁵Hydrophobically modified polyamine according to Example 1.
⁶DTPA = diethylenetriaminepentaacetic acid
⁷Balance to 100% can, for example, include minors like optical brightener, perfume, soil dispersant, chelating agents, dye transfer inhibiting agents, additional water, and fillers, including CaCO₃, talc, silicates, aesthetics, etc. Other additives can include various enzymes, bleach catalysts, perfume encapsulates and others.

What is claimed is:

1. A detergent composition comprising
a) from about 0.01%, preferably from about 0.1%, more preferably from about 1%, most preferably from about 3% to about 50%, preferably to about 20%, more preferably to about 10%, most preferably to about 7% by weight of a hydrophobically modified polyamine having formula (I): 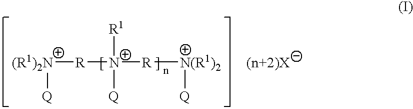
wherein R in formula (I) is C₆-C₂₀ linear or branched alkylene, and mixtures thereof; X in formula (I) is an anion present in sufficient amount to provide electronic neutrality; n in formula (I) has the value from about 0 to about 4; R¹ in formula (I) is a capped polyalkyleneoxy unit having formula (II):
—(R²O)ₓ—R³ (II)
wherein R² in formula (II) is C₂-C₄ linear or branched alkylene, and mixtures thereof; x in formula (II) is from about 1 to about 50; at least one R³ moiety in formula (II) is an anionic capping unit, with the remaining R³ moieties in formula (II) selected from the group comprising hydrogen, C₁-C₂₂ alkylenearyl, an anionic capping unit, a neutral capping unit, and mixtures thereof; wherein at least one Q moiety, but less than all Q moieties in formula (I) are hydrophobic quaternizing units selected from the group comprising C₇-C₃₀ substituted or unsubstituted alkylenearyl, and mixtures thereof, with the remaining Q moieties in formula (I) selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof;
b) a surfactant system comprising from about 0.01% by weight, of a surfactant system comprising one or more surfactants selected from:
i) from 0% to 100% by weight, of one or more anionic surfactants;
ii) from 0% to 100% by weight, of one or more nonionic surfactants;
iii) optionally from 0.1% to about 80% by weight, of one or more cationic surfactants;
iv) optionally from 0.1% to about 80% by weight, of one or more zwitterionic surfactants;
v) optionally from 0.1% to about 80% by weight, of one or more ampholytic surfactants; or
vi) mixtures thereof; and
c) the balance carriers and adjunct ingredients.

2. The detergent composition of claim 1 wherein the hydrophobically modified polyamine further comprises at least one R³ moiety in formula (II) comprising an anionic capping unit selected from the group comprising:
i) —(CH₂)_{f}CO₂⁻;
ii) —C(O)(CH₂)_{f}CO₂⁻;
iii) —(CH₂)_{f}PO₃²⁻;
iv) —(CH₂)_{f}OPO₃²⁻;
v) —(CH₂)_{f}SO₃⁻;
vi) −CH₂(CHSO₃⁻)(CH₂)_{f}SO₃⁻;
vii) —CH₂(CHSO₂⁻)(CH₂)_{f}SO₃⁻;
viii) —C(O)CH₂CH(SO₃⁻)CO₂⁻;
ix) —C(O)CH₂CH(CO₂⁻)NHCH(CO₂⁻)CH₂CO₂⁻;
x) —CH₂CH(OH)CH₂SO₃⁻;
xi) —CH₂CH(SO₃⁻)CH₂OH;
xii) —CH₂PhSO₃⁻;
xiii) —PhSO₃⁻;
xiv) and mixtures thereof;
wherein f is from 0 to about 10.

3. The detergent composition of claim 1 wherein the R³ moiety in formula (II) does not comprises more than 50% by total R³ moiety of the anionic capping unit with the remaining R³ moieties in formula (II) being selected from the group comprising hydrogen, C₁-C₂₂ alkylenearyl, a neutral capping unit, and mixtures thereof.

4. The detergent composition of claim 3 wherein R³ moiety in formula (II) is the anionic capping unit at a level of from about 15% to about 30% by total R³ moiety, more preferred about 20% by total R³ moiety.

5. The detergent of claim 1 wherein the Q moiety in formula (I) comprises between about 90% by total Q moiety and about 99% by total Q moiety of C₇-C₃₀ substituted or unsubstituted alkylenearyl with the remaining percentage of the Q moieties in formula (I) comprising lone pairs of electrons on the unreacted nitrogens, hydrogen, C₁-C₃₀ substituted or unsubstituted linear or branched alkyl, or C₃-C₃₀ substituted unsubstituted cycloalkyl, and mixtures thereof.

6. A detergent composition according to claim 5 wherein the Q moiety in formula (I) comprises between about 90% by total Q moiety and about 99% by total Q moiety of benzyl with the remaining percentage of the Q moieties in formula (I) comprising lone pairs of electrons on the unreacted nitrogens, hydrogen, C₁-C₃₀ substituted or unsubstituted linear or branched alkyl, or C₃-C₃₀ substituted unsubstituted cycloalkyl, and mixtures thereof.

7. The detergent composition of claim 1 wherein the surfactant system comprises:
i) from 1% to about 80% by weight, of an anionic surfactant selected from the group comprising:
a) C₁₁-C₁₈ alkyl benzene sulfonates (LAS);
b) C₁₀-C₂₀ primary, branched-chain and random alkyl sulfates (AS);
c) C₁₀-C₁₈ secondary (2,3) alkyl sulfates having formulae (X) and (XI): 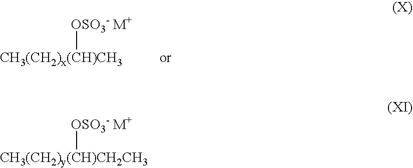
(X) (XI)
wherein x in formulae (X) and (XI) is an integer of at least about 7, preferably at least about 9; y in formulae (X) and (XI) is an integer of at least about 8, preferably at least about 10;
d) C₁₀-C₁₈ alkyl alkoxy sulfates (AE_{X}S) wherein preferably x is from 1-30;
e) C₁₀-C₁₈ alkyl alkoxy carboxylates preferably comprising 1-5 ethoxy units;
f) mid-chain branched alkyl sulfates having formula (XII): 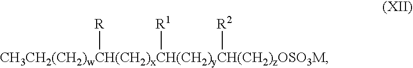
g) alkyl alkoxy sulfates have formula (XIII): 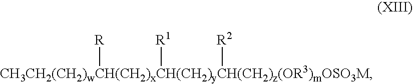
wherein for both the mid-chain branched alkyl sulfates and the alkyl alkoxy sulfates R, R¹, and R² in formulae (XII) and (XIII) are each independently hydrogen, C₁-C₃ alkyl, and mixtures thereof; provided at least one of R, R¹, and R² in formulae (XII) and (XIII) is not hydrogen; w in formulae (XII) and (XIII) is an integer from 0 to 13; x in formulae (XII) and (XIII) is an integer from 0 to 13; y in formulae (XII) and (XIII) is an integer from 0 to 13; z in formulae (XII) and (XIII) is an integer of at least 1; provided w+x+y+z is from 8 to 14 and the total number of carbon atoms in a surfactant is from 14 to 20; R³ in formula (XIII) is C₁-C₄ linear or branched alkylene, preferably ethylene, 1,2-propylene, 1,3-propylene, 1,2-butylene, 1,4-butylene, and mixtures thereof; the average value of the index m in formula (XIII) is at least about 0.01; where M in formulae (XII) and (XIII) denotes a cation;
h) mid-chain branched aryl sulphonates having formula(XVIII): 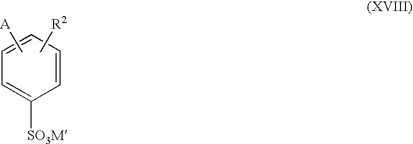
wherein A in formula (XVIII) is a rnid-chain branched alkyl unit having formula (XIX): 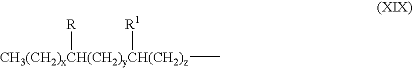
wherein R and R¹ are each independently hydrogen, C₁-C₃ alkyl, and mixtures thereof, provided at least one of R and R¹ in formula (XIX) is not hydrogen; wherein the total number of carbon atoms in said alkyl unit is from 6 to 18; x in formula (XIX) is from 0 to 13; y in formula (XIX) is from 0 to 13; z in formula (XIX) is either 0 or 1; R² in formula (XVIII) is hydrogen, C₁-C₃ alkyl, and mixtures thereof; M′ in formula (XVIII) denotes a water soluble cation with sufficient charge to provide neutrality; or
l) mixtures thereof;
ii) from 0% to 80% by weight of one or more nonionic surfactants;
iii) optionally from 0.1% to about 80% by weight, of one or more cationic surfactants;
iv) optionally from 0.1% to about 80% by weight, of one or more zwitterionic surfactants;
v) optionally from 0.1% to about 80% by weight, of one or more ampholytic surfactants; or
vi) mixtures thereof.

8. The detergent composition of claim 1 wherein the surfactant system comprises:
i) from about 85% to about 99.9% by weight of one or more nonionic surfactants;
ii) optionally, from about 0.1% to about 15% by weight, of one or more anionic surfactants;
iii) optionally, from about 0.1% to about 14% by weight, of one or more cationic surfactants;
iv) optionally, from about 0.1% to about 15% by weight of one or more zwitterionic surfactants
v) optionally, from about 01% to about 15% by weight, of one or more ampholytic surfactants; or
vi) mixtures thereof.

9. The detergent composition according to claim 1 wherein R in formula (I) is C₆-C₁₀ alkylene, and mixtures thereof.

10. The detergent composition according to claim 9 wherein R in formula (I) is hexylene.

11. The detergent composition according to claim 1 wherein R² in formula (II) is ethylene, 1,2-propylene, and mixtures thereof.

12. The detergent composition according to claim 11 wherein R² in formula (II) is ethylene.

13. The detergent composition according to claim 1 wherein the index x in formula (II) is from 15 to 25.

14. The detergent composition according to claim 13 wherein the index x in formula (II) is 20.

15. The detergent composition according to claim 1 wherein the index n in formula (I) is 0 or 1.

16. The detergent composition according to claim 1 wherein said hydrophobically modified polyamine has formula (III): 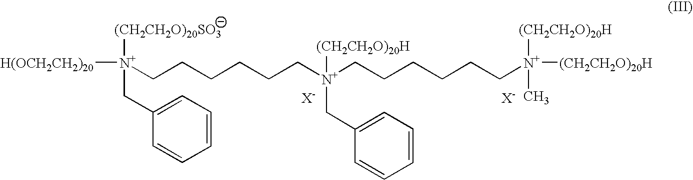
wherein X in formula (III) is a water soluble anion selected from the group comprising chlorine, bromine, iodine, methylsulfate, and mixtures thereof.

17. The detergent composition according to claim 1 wherein said hydrophobically modified polyamine has formula (IV): 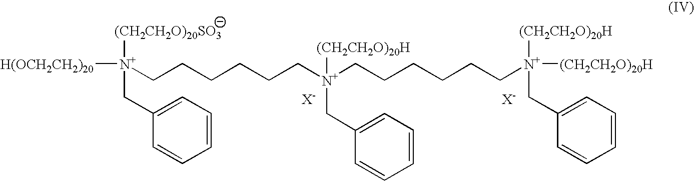
wherein the benzyl groups quaternize about 90% by Q moiety to about 99% by Q moiety in formula (I); X in formula (IV) is a water soluble anion selected from the group comprising chlorine, bromine, iodine, methylsulfate, and mixtures thereof.

18. The detergent composition according to claim 1 further comprising about 1% by weight of a builder.

19. The detergent composition according to claim 1 further comprising from about 1% by weight, of a peroxygen bleaching system comprising:
i) from about 40% by weight, of the bleaching system, a source of hydrogen peroxide;
ii) optionally from about 0.1% by weight, of the beaching system, a beach activator;
iii) optionally from about 1 ppb of the composition, of a transition-metal bleach catalyst; and
iv) optionally from about 0.1% by weight, of a pre-formed peroxygen bleaching agent.

20. A detergent composition comprising:
A) from about 0.01% by weight of a hydrophobically modified polyamine having formula (III): 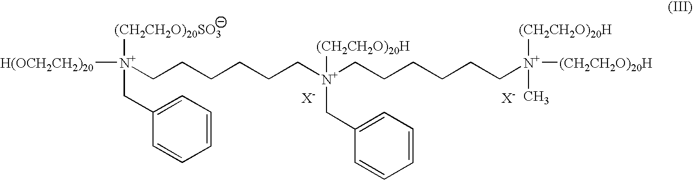
wherein X in formula (III) is a water soluble anion selected from the group comprising chlorine, bromine, iodine, methylsulfate, and mixtures thereof
B) from about 0.01% to about 60% by weight, of a surfactant system comprising one or more surfactants selected from:
i) from 0% to 100% by weight, of one or more anionic surfactants;
ii) from 0% to 100% by weight, of one or more nonionic surfactants;
iii) optionally from 0.1% to about 80% by weight, of one or more cationic surfactants;
iv) optionally from 0.1% to about 80% by weight, of one or more zwitterionic surfactants;
v) optionally from 0.1% to about 80% by weight, of one or more ampholytic surfactants; or
vi) mixtures thereof;
C) the balance carriers and adjunct ingredients.

21. A detergent composition comprising:
A) from about 0.01% by weight of a hydrophobically modified polyamine having formula (IV): 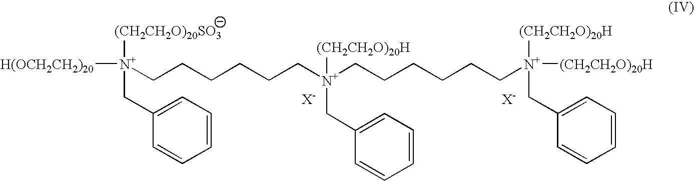
wherein the benzyl groups quaternize about 90% by Q moiety to about 99% by Q moiety in formula (I); X in formula (IV) is a water soluble anion selected from the group comprising chlorine, bromine, iodine, methylsulfate, and mixtures thereof
B) from about 0.01% to about 60% by weight, of a surfactant system comprising one or more surfactants selected from:
i) from 0% to 100% by weight, of one or more anionic surfactants;
ii) from 0% to 100% by weight, of one or more nonionic surfactants;
iii) optionally from 0.1% to about 80% by weight, of one or more cationic surfactants;
iv) optionally from 0.1% to about 80% by weight, of one or more zwitterionic surfactants;
v) optionally from 0.1% to about 80% by weight, of one or more ampholytic surfactants; or
vi) mixtures thereof;
C) the balance carriers and adjunct ingredients.

22. A method for cleaning fabric comprising the step of contacting an article of fabric with an aqueous solution containing at least 0.1% by weight of a composition comprising:
A) from about 0.01% to about 50% by weight of a hydrophobically modified polyamine having formula (I): 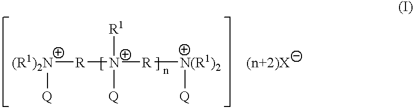
wherein R in formula (I) is C₅-C₂₀ linear or branched alkylene, and mixtures thereof; R¹ in formula (I) is an alkyleneoxy unit having formula (II):
—(R²O)ₓ—R³ (II)
wherein R² in formula (II) is C₂-C₄ linear or branched alkylene, and mixtures thereof; R³ in formula (II) is at least one anionic unit selected from the group comprising:
i) —(CH₂)_{f}C₂⁻;
ii) —C(O)(CH₂)_{f}CO₂⁻;
iii) —(CH₂)_{f}PO₃²⁻;
iv) —(CH₂)_{f}OPO₃²⁻;
v) —(CH₂)_{f}SO₃⁻;
vi) —CH₂(CHSO₃⁻)(CH₂)_{f}SO₃⁻;
vii) —CH₂(CHSO₂⁻)(CH₂)_{f}SO₃⁻;
viii) —C(O)CH₂CH(SO₃⁻)CO₂⁻;
ix) —C(O)CH₂CH(CO₂⁻)NHCH(CO₂⁻)CH₂CO₂⁻;
x) —CH₂CH(OH)CH₂SO₃⁻;
xi) —CH₂CH(SO₃⁻)CH₂OH;
xii) —CH₂PhSO₃⁻;
xiii) —PhSO₃⁻;
xiv) and mixtures thereof;
wherein the index f in the anionic capping units is from 0 to about 10; x in formula (II) is from about 15 to about 30; with the remaining R³ moieties in formula (II) selected from the group comprising hydrogen, C₁-C₂₂ alkylenearyl, the anionic capping units above, a neutral capping unit, and mixtures thereof; wherein at least one, but less than all Q moieties in formula (I) are hydrophobic quaternizing units selected from the group comprising C₇-C₃₀ substituted or unsubstituted alkylenearyl, and mixtures thereof, with the remaining Q moieties in formula (I) selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof; X in formula (I) is an anion present in sufficient amount to provide electronic neutrality; n in formula (I) is from 0 to 4;
B) from about 0.01% to about 60% by weight, of a surfactant system comprising one or more surfactants selected from:
i) from 0% to 100% by weight, of one or more anionic surfactants;
ii) from 0% to 100% by weight, of one or more nonionic surfactants;
iii) optionally from 0.1% to about 80% by weight, of one or more cationic surfactants;
iv) optionally from 0.1% to about 80% by weight, of one or more zwitterionic surfactants;
v) optionally from 0.1% to about 80% by weight, of one or more ampholytic surfactants; or
vi) mixtures thereof;
C) the balance carriers and adjunct ingredients.

23. A hydrophobically modified polyamine having formula (I): 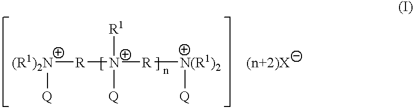
wherein R in formula (I) is C₅-C₂₀ linear or branched alkylene, and mixtures thereof; R¹ in formula (I) is an alkyleneoxy unit having formula (II):
—(R²O)ₓ—R³ (II)
wherein R² in formula (II) is C₂-C₄ linear or branched alkylene, and mixtures thereof; R³ in formula (II) is at least one anionic unit selected from the group comprising:
i) —(CH₂)_{f}CO₂⁻;
ii) —C(O)(CH₂)_{f}C₂⁻;
iii) —(CH₂)_{f}PO₃²⁻;
iv) —(CH₂)_{f}OPO₃²⁻;
v) —(CH₂)_{f}SO₃⁻;
vi) —CH₂(CHSO₃⁻)(CH₂)_{f}SO₃⁻;
vii) —CH₂(CHSO₂⁻)(CH₂)_{f}SO₃⁻;
viii) —C(O)CH₂CH(SO₃⁻)CO₂⁻;
ix) —C(O)CH₂CH(CO₂⁻)NHCH(CO₂⁻)CH₂CO₂⁻;
x) —CH₂CH(OH)CH₂SO₃⁻;
xi) —CH₂CH(SO₃⁻)CH₂OH;
xii) —CH₂PhSO₃⁻;
xiii) —PhSO₃⁻;
xiv) and mixtures thereof;
wherein the index f in the anionic capping units is from 0 to about 10; x in formula (II) is from about 15 to about 30; with the remaining R³ moieties in formula (II) selected from the group comprising hydrogen, C₁-C₂₂ alkylenearyl, the anionic capping units above, a neutral capping unit, and mixtures thereof; wherein at least one Q moiety, but less than all Q moieties in formula (I) are hydrophobic quaternizing units selected from the group comprising C₇-C₃₀ substituted or unsubstituted alkylenearyl, and mixtures thereof, with the remaining Q moieties in formula (I) selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof; X in formula (I) is an anion present in sufficient amount to provide electronic neutrality; n in formula (I) is from 0 to 4;

24. The hydrophobically modified polyamine of claim 21 wherein the anionic capping unit is selected from the group consisting of:
x) —CH₂CH(OH)CH₂SO₃⁻;
xi) —CH₂CH(SO₃⁻)CH₂OH;
xii) —CH₂PhSO₃⁻;
xiii) —PhSO₃⁻; and
xiv) mixtures thereof.
